(19) United States
(12) Patent Application Publication
(10) Pub. No.: US 2008/0136782 A1
(43) Pub. Date: Jun. 12, 2008

(54) System and Method for Powering Information Handling System Keyboard Illumination

(76) Inventors: Kevin Mundt, Austin, TX (US); Jefferson W. Wirtz, Round Rock, TX (US)

Correspondence Address: HAMILTON & TERRILE, LLP, P.O. BOX 203518, AUSTIN, TX, 78720, US

(21) Appl. No.: 11/608,901

(22) Filed: Dec. 11, 2006

(51) Int. Cl. G06F 3/01

(52) U.S. Cl. 345/170

(57) ABSTRACT

An information handling system keyboard assembly interfaces with an information handling system through a connector that communicates user inputs made at a keyboard and provides power for illumination. Illumination traces formed in a keyboard matrix extend between the connector and an illumination circuit coupling point located proximate the connector. The illumination circuit connects with the illumination traces with a conductive adhesive or mechanical connector so that power is provided from the connector through the illumination traces of the membrane to the illumination circuit to illuminate the keyboard. Keyboard matrix traces extend from the matrix to the connector so that keyboard communication and power are both made through the same connector.

### BACKGROUND OF THE INVENTION

1. Field of the Invention

The present invention relates in general to the field of information handling system keyboards, and more particularly to a system and method for powering information handling system keyboard illumination.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As components for information handling systems have put greater processing power in smaller packages, information handling systems have also provided greater processing capabilities into smaller chassis. One example of this trend is the increasing popularity of portable information handling systems. Portable information handling systems are self-contained systems that have an internal power source and integrated peripherals, such as a display and keyboard, in a common chassis so that end users can carry the system while it operates independent of a fixed power outlet or peripherals. Many end users have adopted portable information handling systems as their primary systems due to this convenience. For example, a businessman can develop and save a presentation at his office, practice the presentation on a plane ride and give the presentation to an audience, all with the same portable information handling system.

One difficulty with using portable information handling systems “on the go” is that lighting conditions are sometimes less than optimal, making the keyboard legend difficult to discern. In an effort to address this difficulty, information handling system manufacturers are integrating illuminated keyboards into portable information handling system chassis. An illuminated keyboard assembly typically includes keypads placed over a membrane printed with a silver based conductive ink. The membrane ink creates conductive traces formed as a matrix that align with the keypads so that an electrical signal is generated that identifies which keypad is pressed. The membrane traces terminate at a membrane connector that couples to a cable that communicates the keyboard signals to a keyboard controller for decoding. Illumination is typically provided by a flexible printed circuit, which provides power to low profile LEDs to generate light. The light is distributed across the keys of the keypad by a light guide assembled between the keypad and the flexible printed circuit. The flexible printed circuit terminates at an illumination connector, which connects to a power source to provide illumination of the LEDs. The keyboard assembly typically fits in an opening at the top of the portable chassis to cover internal components. The keyboard assembly is typically removable to provide access to the internal components, such as to add memory or perform maintenance. To remove and re-attach the keyboard assembly, both the membrane connector and illumination connector are detached and re-attached.

### SUMMARY OF THE INVENTION

Therefore a need has arisen for a system and method which powers keyboard illumination from an information handling system chassis with a single keyboard connector.

In accordance with the present invention, a system and method are provided which substantially reduce the disadvantages and problems associated with previous methods and systems for powering information handling system illumination. Power is provided to illuminate a keyboard at a connector that also communicates user inputs from the keyboard to an information handling system. For example, power is routed from a connector through a keyboard membrane to a coupling point on the membrane at which an illumination circuit is coupled.

More specifically, a portable information handling system has processing components, a power source and a display integrated in a portable chassis. A keyboard assembly fits in an opening of the chassis to cover the processing components and provide an integrated keyboard that accepts user inputs. A keyboard cable interfaces the processing components with the keyboard assembly through a single connector formed at the keyboard assembly. A matrix formed in a membrane with silver ink terminates with matrix traces at the connector. Illumination traces formed in the membrane with silver ink extend from the connector to an illumination circuit coupling point located proximate the connector. An illumination circuit connects to the illumination traces at the coupling point, such as with a conductive adhesive or a mechanical spring plate, so that power is provided from the connector through the illumination traces to the illumination circuit. The coupling point is strengthened and its resistance is decreased by placing carbon ink over the illumination traces.

The present invention provides a number of important technical advantages. One example of an important technical advantage is that keyboard illumination is powered from an information handling system chassis with a single keyboard connector. The use of a single keyboard connector instead of separate membrane and illumination connectors makes insertion and removal of a keyboard assembly in a portable information handling system chassis less complex. Integrating the illumination connector through the keyboard membrane to a keyboard connector shared in common with the membrane connector provides reliable power to the flexible printed circuit with a single connection between the keyboard assembly and the chassis. Integration of the illumination connector through the keyboard membrane with a conductive material provides continuity of the connection of power to the flexible printed circuit to minimize the impact of resistance introduced by the keyboard membrane.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a portable information handling system having an illuminated keyboard assembly supported through a single keyboard connector;

FIG. 2 depicts a blow-up perspective view of an illuminated keyboard assembly having a single keyboard connector;

FIG. 3 depicts a blow-up inverted view of a keyboard membrane and illumination circuit aligned to couple at a common connector; and

FIG. 4 depicts keyboard membrane matrix and illumination traces terminating at a common connector.

### DETAILED DESCRIPTION

Supporting illumination of an information handling system keyboard through a connector formed in the keyboard membrane reduces the complexity of assembly and disassembly of the information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

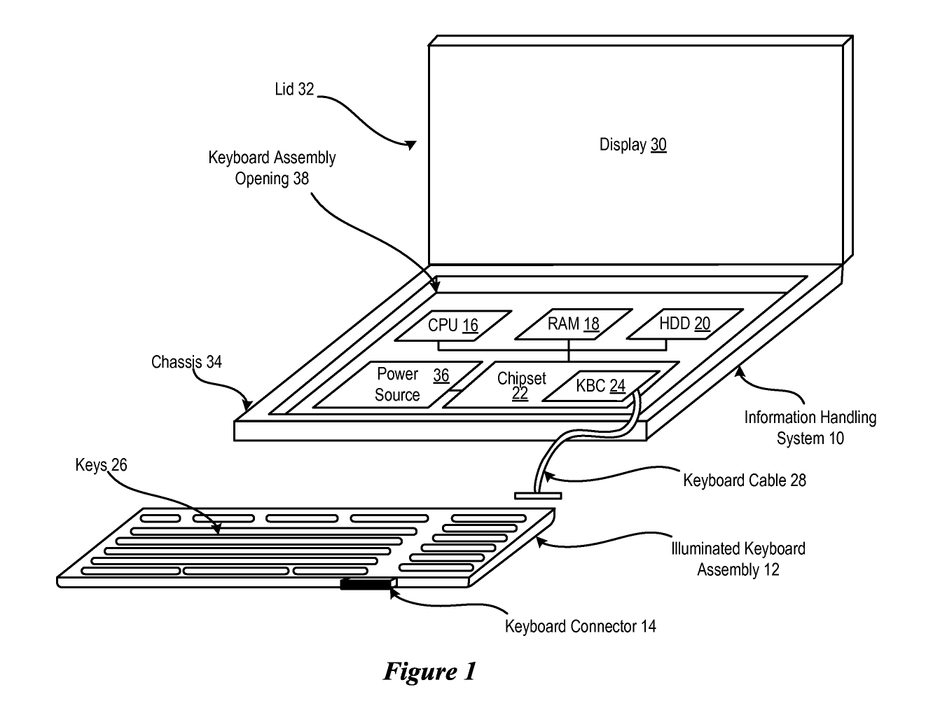

Referring now to FIG. 1, a portable information handling system 10 is depicted having an illuminated keyboard assembly 12 supported through a single keyboard connector 14. Portable information handling system 10 has plural processing components that cooperate to process information, such as a CPU 16, RAM 18, a hard disk drive 20 and a chipset 22. Chipset 22 includes a keyboard controller 24 which accepts electrical signals generated by user inputs at keys 26 and communicated through a keyboard cable 28. Information is presented at a display 30 integrated in a lid 32 of a chassis 34 which supports the processing components. Portable information handling system 10 is a self-contained unit able to operate independent of fixed resources with power provided by an internal power source 36, such as a battery. Keyboard cable 28 communicates keyboard inputs to chipset 22 and also provides power from power source 36 to an illumination circuit within keyboard assembly 12 to illuminate keys 26. Keyboard cable 28 couples to keyboard assembly 12 through a single keyboard connector 14 to advantageously allow assembly and disassembly of keyboard assembly 12 into the opening 38 at the top of chassis 34 with a single cable connection.

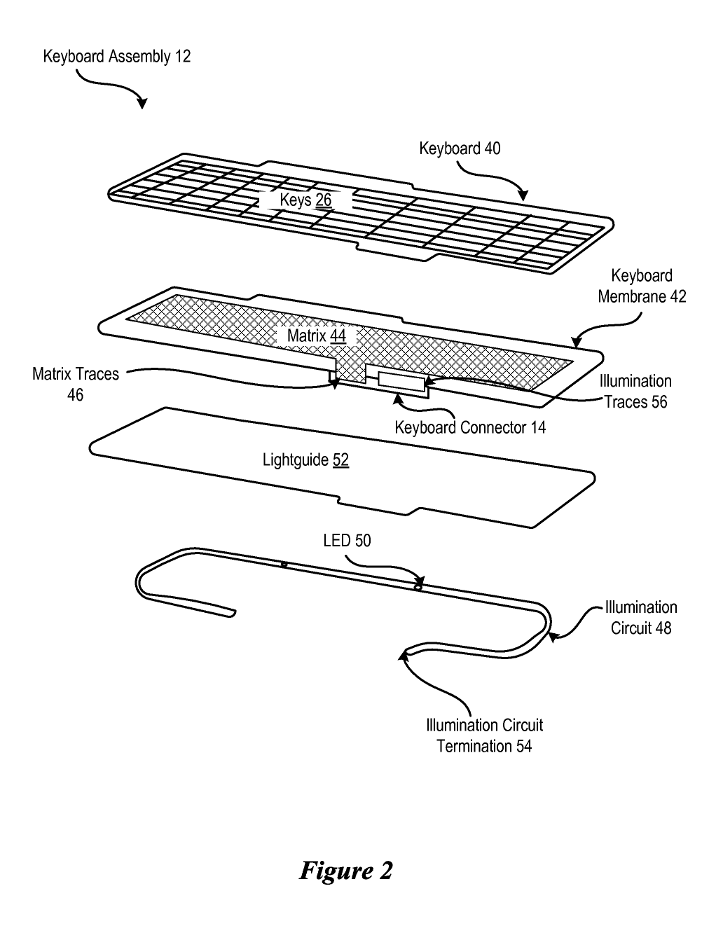

Referring now to FIG. 2, a blow-up perspective view depicts an illuminated keyboard assembly 12 having a single keyboard connector 14. Keyboard assembly 12 has a keyboard 40 with keys 26 aligned over a keyboard membrane 42 having a matrix 44. Matrix 44 has silver ink traces disposed in a pattern so that a user input at a key 26 generates an electrical signal along associated matrix traces 46 that is communicated to keyboard connector 14. Illumination is provided to keys 26 with an illumination circuit 48 having plural LEDs 50 or other source of illumination, such as electroluminescent (EL) backlight assemblies. LEDs 50 provide light to a light guide 52 which directs the light towards keys 26 for even distribution across keys 26. Illumination circuit 48 receives power at an illumination circuit termination 54. Illumination circuit termination 54 interfaces with power provided through keyboard connector 14 by coupling to illumination traces 56 formed in keyboard membrane 42 proximate to connector 14. Thus, power is provided to illumination circuit 48 through a single connector 14 by routing the power for short distance through membrane 42 with silver ink illumination traces 56. By keeping the length of illumination traces 56 to a minimum, the generally higher resistive properties of silver ink in membrane 42 has minimal impact on power delivery to illumination circuit 48.

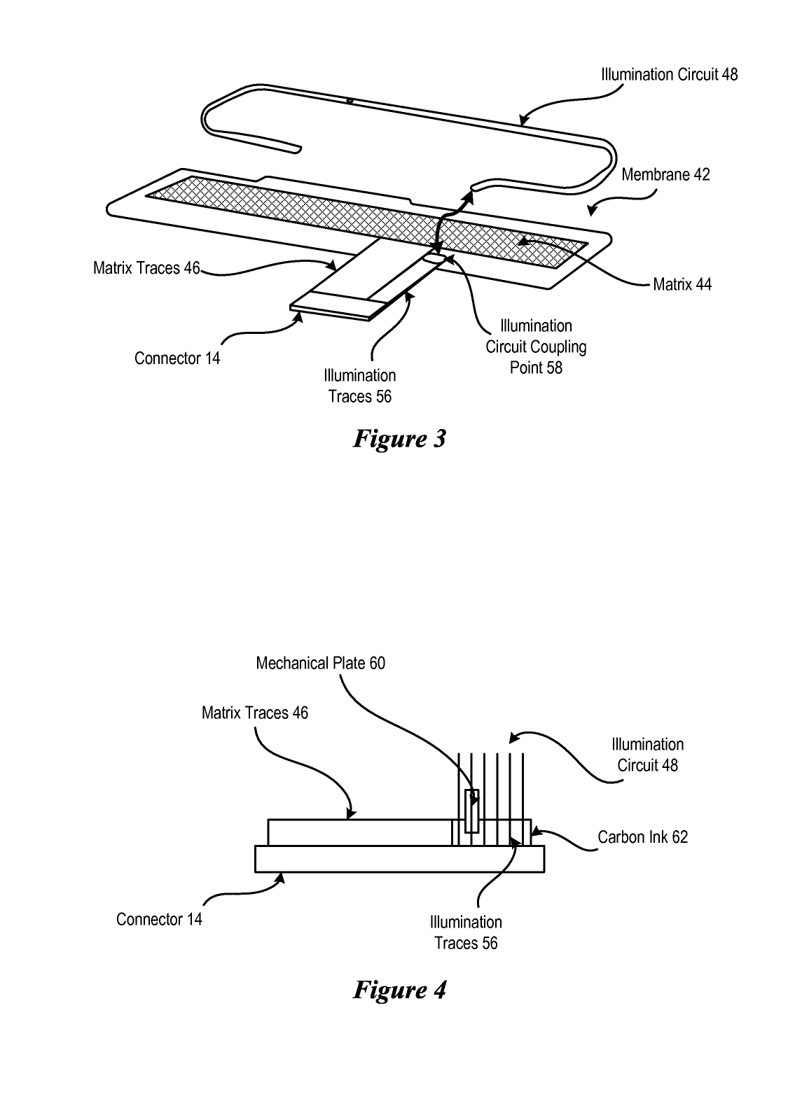

Referring now to FIG. 3, a blow-up inverted view depicts a keyboard membrane 42 and illumination circuit 48 aligned to couple at a common connector 14. Illumination circuit 48 connects to illumination traces 56 at an illumination circuit coupling point 58. Illumination circuit 48 is connected with a conductive adhesive or a mechanical connector, such as a spring plate, so that power communicates through connector 14 and illumination traces 56 to illumination circuit 48 to illuminate LEDs and provide illumination. By routing power through membrane 42 with illumination traces 56, membrane 42 and illumination circuit 48 are assembled as a unit for further assembly into information handling system 10 with a single cable connector 14. Illumination circuit 48 is, for instance, a flexible printed circuit having traces to power LEDs or ELs with a lower resistance than the silver ink traces used to form matrix 44.

Referring now to FIG. 4, keyboard membrane matrix and illumination traces are depicted terminating at a common connector 14. Matrix traces 46 are formed with silver ink to communicate electrical signals from matrix 44 to connector 14. Illumination traces 56 are formed with silver ink to extend from the illumination circuit coupling point 58 to connector 14. Illumination circuit 48 is a flexible printed circuit having traces that align with illumination traces 56 and that are coupled to illumination traces 56, such as with a conductive adhesive or with a mechanical plate 60. In order to improve the strength of the physical connection between illumination circuit 48 and illumination traces 56, carbon ink 62 or other type of conductive ink is placed over the traces at the physical connection. To overcome the increased resistance of the silver ink that forms illumination traces 56 in membrane 42, the carbon ink is extended across the length of illumination traces 56. In this manner, power and information communication are integrated through the single connector 14.

Although the present invention has been described in detail, it should be understood that various changes, substitutions and alterations can be made hereto without departing from the spirit and scope of the invention as defined by the appended claims.

What is claimed is:

1. An information handling system comprising:
a chassis having a top side and a lid;
processing components disposed in the chassis and operable to process information;
a display disposed in the lid and interfaced with the processing components, the display operable to present the information;
an internal power source disposed in the chassis and operable to power the processing components and the display;
a keyboard assembly disposed in the chassis top side, the keyboard assembly having a membrane operable to detect user inputs and an illumination circuit operable to provide illumination, the membrane and illumination circuit terminating at a single keyboard connector; and
a cable coupling to the keyboard connector to interface the membrane with the processing components and to interface the illumination circuit with the power source.

2. The information handling system of claim 1 wherein the illumination circuit comprises a flexible printed circuit terminating at the membrane proximate the keyboard connector and traces extending from the flexible printed circuit through the membrane to the keyboard connector.

3. The information handling system of claim 2 further comprising a conductive adhesive coupling the flexible printed circuit to the membrane.

4. The information handling system of claim 2 further comprising a mechanical plate coupling the flexible printed circuit to the membrane.

5. The information handling system of claim 2 further comprising a conductive material added to the traces extending from the flexible printed circuit through the membrane to the keyboard connector.

6. The information handling system of claim 5 wherein the conductive material comprises conductive carbon ink printed over the traces.

7. The information handling system of claim 1 wherein the illumination circuit further comprises plural LEDs operable to provide illumination.

8. A method for powering information handling system keyboard illumination, the method comprising:
disposing an illumination circuit proximate a keyboard membrane;
terminating the illumination circuit and keyboard membrane to a single connector;
coupling a cable to the connector; and
interfacing the cable with a keyboard controller to receive inputs from the keyboard membrane and with a power source to power the illumination circuit.

9. The method of claim 8 wherein terminating the illumination circuit and keyboard membrane to a single connector further comprises:
terminating the illumination circuit at traces of the keyboard membrane; and
providing power from the connector through the keyboard membrane traces to the illumination circuit.

10. The method of claim 9 wherein the illumination circuit comprises a flexible printed circuit having plural LEDs.

11. The method of claim 9 wherein terminating the illumination circuit at traces of the keyboard membrane further comprises coupling the illumination circuit to the keyboard membrane with a conductive adhesive.

12. The method of claim 9 wherein terminating the illumination circuit at traces of the keyboard membrane further comprises coupling the illumination circuit to the keyboard membrane with a mechanical plate.

13. The method of claim 9 further comprising adding a conductive material to the membrane traces between the connector and the illumination circuit.

14. The method of claim 13 wherein the conductive material comprises carbon ink.

15. A keyboard assembly comprising:
a keyboard membrane having matrix traces forming a matrix operable to generate electrical signals to identify inputs made at the keyboard, the matrix traces terminating at a connector;
illumination traces formed in the membrane proximate the connector; and
an illumination circuit having plural LEDs operable to provide illumination, the illumination circuit terminating at the illumination traces to provide power from the connector through the illumination traces to the illumination circuit.

16. The keyboard assembly of claim 15 further comprising a conductive material provided over the illumination traces.

17. The keyboard assembly of claim 16 wherein the conductive material comprises carbon ink.

18. The keyboard assembly of claim 15 further comprising a light guide proximate the illumination circuit and operable to direct light to keys associated with the membrane matrix.

19. The keyboard assembly of claim 15 wherein the illumination circuit couples to the membrane with a conductive adhesive.

20. The keyboard assembly of claim 15 wherein the illumination circuit couples to the membrane with a mechanical plate.
